(19) United States
(12) Patent Application Publication
(10) Pub. No.: US 2013/0153493 A1
(43) Pub. Date: Jun. 20, 2013

(54) MOVING BED MEMBRANE BIOREACTOR

(71) Applicants: Stephanie Young, Regina (CA); Alex Munoz, Regina (CA)

(72) Inventors: Stephanie Young, Regina (CA); Alex Munoz, Regina (CA)

(73) Assignee: UNIVERSITY OF REGINA, Regina, SK (CA)

(21) Appl. No.: 13/816,767

(22) PCT Filed: Aug. 15, 2011
(86) PCT No.: PCT/CA2011/000926

§ 371 Date: Mar. 5, 2013

Related U.S. Application Data
(60) Provisional application No. 61/373,733, filed on Aug. 13, 2010.

(51) Int. Cl. C02F 3/12

(52) U.S. Cl. CPC C02F 3/1268
USPC 210/615; 210/151; 210/108; 210/137

(57) ABSTRACT

This disclosure relates to a moving bed membrane bioreactor. The moving bed membrane bioreactor package plant comprises a pre-treatment system, a moving bed membrane bioreactor, and a post-treatment system. This disclosure further relates to mechanical devices and operational processes for a moving bed membrane bioreactor package plant for greywater and wastewater reclamation and reuse. This disclosure further relates to a bioreactor for greywater reclamation that integrates biofilm carriers with a hollow fibre membrane module and dual aeration system.

### FIELD

This disclosure relates to a moving bed membrane bioreactor. This disclosure further relates to mechanical devices and operational processes for a moving bed membrane bioreactor package plant (hereinafter referred to as “package plant”) for greywater and wastewater reclamation and reuse. This disclosure further relates to a bioreactor for greywater reclamation that integrates biofilm carriers with a hollow fibre membrane module and dual aeration system. This disclosure further relates to hollow fibre membrane modules for a moving bed membrane bioreactor.

### BACKGROUND

There is growing awareness that clean water is a limited resource that needs to preserved, recycled, and reused. In particular, concerns over dwindling reserves of groundwater and the cost of treating sewage has led to an interest in finding ways of managing water usage in a more efficient manner. Recently, water reclamation and reuse have become an attractive alternative for conserving and extending available water supplies by substituting reclaimed water for applications that do not require high-quality drinking water, and for reducing wastewater load in the areas where the sewage collection systems have reached their maximum capacities.

Greywater is waste water generated by domestic activities such as laundry, bathing, dish-washing, etc. Greywater accounts for 50-80% of residential wastewater. Blackwater refers to wastewater containing human or animal waste. Wastewater is typically removed via the sewage system to a water-treatment plant. The wastewater is then treated at the treatment plant to limit pollution and contamination risks prior to discharge. Rather than elimination through the sewage system greywater has been used for irrigation of plants. However, certain residues in the greywater such as soap and salt can be toxic to microbial or plant life.

Various systems have been proposed for treating wastewater. See, for example, WO2008/141113 or U.S. Pat. No. 6,752,926.

Conventional membrane bioreactors (MBR) are widely used for municipal and industrial wastewater treatment. MBRs typically use a suspended growth activated sludge process to biodegrade organic contaminants in conjunction with membrane filtration to separate clean water from the mixed liquor in the bioreactor. This configuration reduces the area needed for treatment in comparison to an activated sludge process and is often used to retrofit existing wastewater treatment plants. In general, conventional MBRs have a biomass concentration that results in extended treatment times and low efficiency of contaminant removal. Additionally, they suffer from frequent membrane fouling and low tolerance to variability of wastewater flow-rate and toxic contamination. Furthermore, conventional MBRs cannot accommodate nitrogen removal in a single bioreactor tank.

Conventional membrane bioreactors can be arranged in two configurations: external or internal MBRs. Internal (or submerged) MBRs are widely used because they generally requires less space, uses fewer pumps and consumes less energy than external MBRs. However, submerged MBRs have lower water flux and suffer from more frequent membrane fouling than external MBRs. In addition, the membrane module cannot be cleaned easily, because it is submerged and needs to be removed from the bioreactor tank for chemical cleaning.

### SUMMARY

The present bioreactors may be used for biological greywater reclamation and non-potable reuse in small community applications. In addition, the present bioreactors may be scaled to suit large community requirements, used for wastewater (sewage) reclamation and reuse, or even used to produce potable water.

The present disclosure provides a package plant. The package plant comprises a moving bed membrane bioreactor, along with pre-treatment and post-treatment processes.

The present package plant may include the following features: small and compact, automated and robust, low maintenance, reliable and stable, high treatment efficiency, low sludge production, and/or low capital and operational costs. The present package plant may be able to cope with variations in chemical inputs and flow. The present package plant can lead to space and cost savings by reducing the number of bioreactors and pumps, and/or using upward flow and integrated processes. The present plant may be used to treat greywater such that its quality is improved to the point it can be reused.

Reliability and compact design are the important features for the successful application of a package plant for such uses as irrigation, toilet flushing, sanitary cleaning, shower and hand washing in residential and commercial buildings, small communities, schools, farms, airports, golf courses, etc. Using reclaimed water can not only reduce fresh water consumptions but it can also reduce wastewater flow-rate and, as such, can reduce the treatment costs in wastewater treatment plants.

The present disclosure provides a moving bed membrane bioreactor. The present moving bed membrane bioreactor integrates the technologies of suspended and attached growth of activated sludge processes, in conjunction with membrane filtration process. It combines MBR technology with moving bed biofilm technology. The present moving bed membrane bioreactor can integrate five treatment units into one bioreactor tank, which are biofilm carriers, hollow fibre membrane modules, an air scour system, a dual aeration system, and permeate collection and backwash control system. The present moving bed membrane bioreactor can be less susceptible to fouling and/or can provide for nitrogen removal in a single tank via an invented automated aeration control system.

The present disclosure provides hollow fibre membrane modules. Three patterns of the hollow fibre module are exemplified—linear loop pattern, circular loop pattern and twist pattern. The present modules are compact and less susceptible to membrane fouling.

As used herein, the term “wastewater” refers to greywater or blackwater. It can be any wastewater that has been adversely affected in quality by anthropogenic activities.

As used herein, the term “bioreactor” refers to a tank in which organisms, or active substances derived from organisms, digest organic contaminants in wastewater. The process may be aerobic, anoxic or anaerobic, or facultative that can utilize both aerobic and anaerobic processes. Biodegradation reactions occur preferably under aerobic/anoxic reactions. In certain embodiments nitrogen can be removed by nitrification under aerobic conditions and denitrification under anoxic conditions.

This summary does not necessarily describe all features of the invention. Other aspects, features and advantages of the invention will be apparent to those of ordinary skill in the art upon review of the following description of specific embodiments of the invention.

### BRIEF DESCRIPTION OF THE DRAWINGS

FIG. 1 shows a schematic of the package plant for wastewater treatment;

FIG. 2 shows a configuration of the moving bed membrane bioreactor;

FIG. 3 shows a membrane module with a linear loop pattern;

FIG. 4 shows a membrane module with a circular loop pattern;

FIG. 5 shows a membrane module base for the circular loop pattern;

FIG. 6 shows a membrane module with a twist pattern;

FIG. 7 shows membrane module bases for the twist pattern;

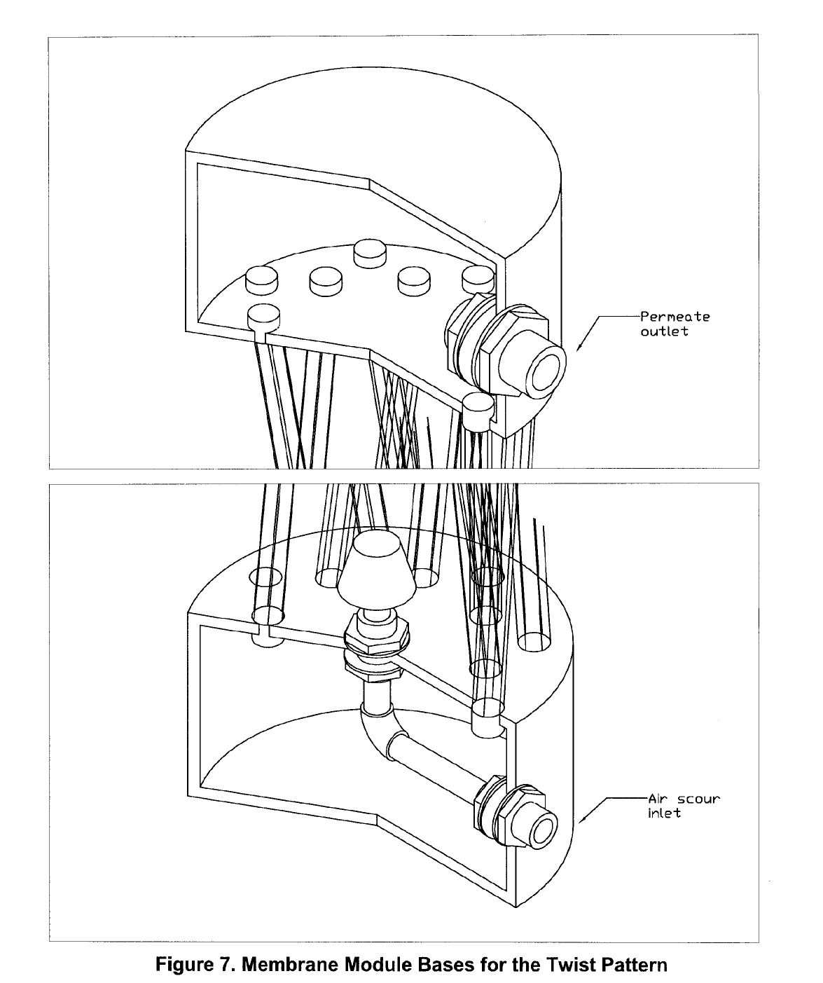

FIG. 8 shows retention sieves in the moving bed membrane bioreactor for the biofilm carriers;

FIG. 9 shows an air diffuser arrangement;

FIG. 10 shows a structure of the expert system for the package plant operation.

### DETAILED DESCRIPTION

The present disclosure provides a package plant, a moving bed membrane bioreactor, and hollow fibre membrane modules.

The package plant is designed for biological greywater reclamation and wastewater treatment. The package plant is capable of treating greywater or sewage of the quality that can be reused in various applications.

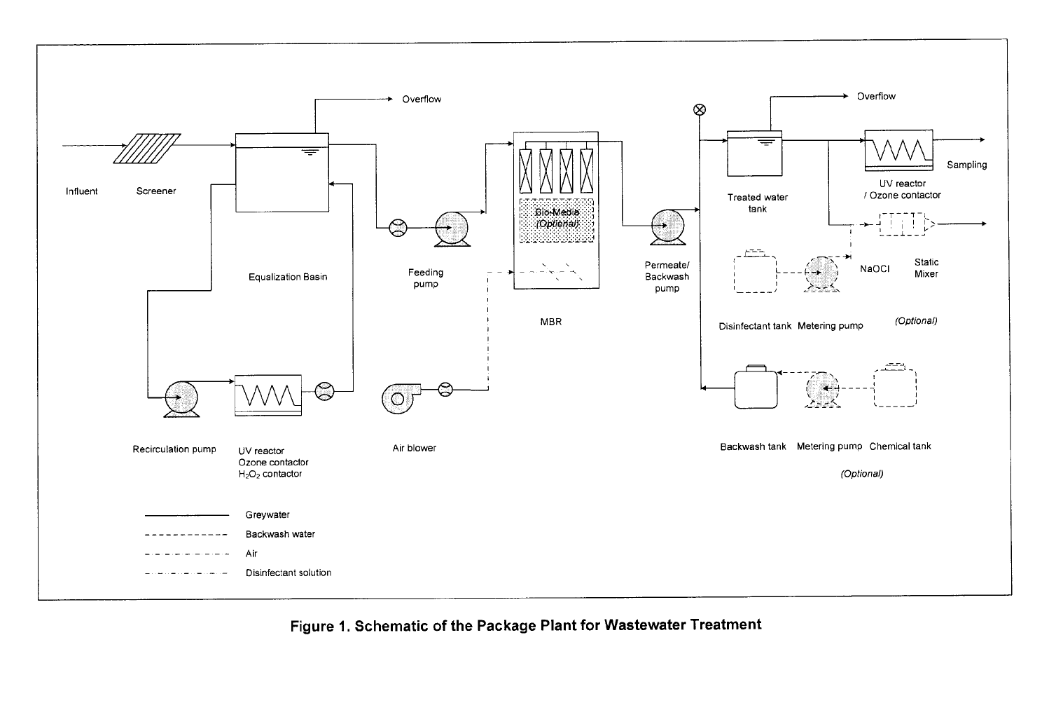

The package plant shown in FIG. 1 includes pre-treatment, a moving bed membrane bioreactor, and post-treatment.

In an embodiment, the pre-treatment system comprises coarse and fine screens followed by an equalization tank with a recirculation system. The recirculation system may comprise a pump that re-circulates the raw greywater from the equalization tank through an ultraviolet (UV) radiation reactor, ozone contactor or hydrogen peroxide contactor. The purpose of this system is to control microbial growth in the greywater and biofilm formation on the wall of the equalization basin and the circulation pipes. In addition, the system may control odour generation.

In an embodiment, the post-treatment system comprises an ultraviolet (UV) radiation reactor and/or an ozone contactor, which is provided as a secondary microorganism reduction mechanism in the unlikely event that a pathogen passes through the membrane. A small amount of sodium hypochlorite may be added in the claimed greywater as a secondary disinfectant to prevent from the re-growth of microorganisms in the distribution pipeline when it is reused.

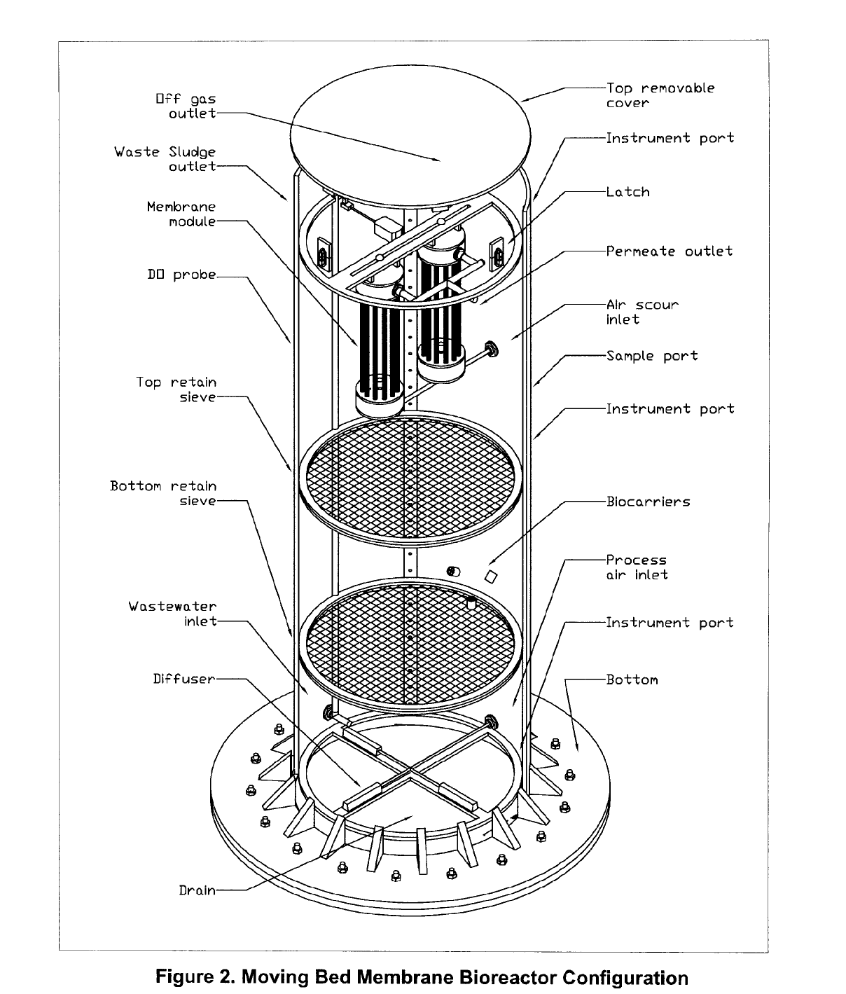

An embodiment of the moving bed membrane bioreactor is shown in FIG. 2 and comprises a bioreactor tank, membrane module(s), biofilm carrier(s), air scour system, dual aeration system, and permeate collection and backwash control system. In this embodiment, the bioreactor tank houses the membrane modules, air scour system and permeate collection system at top section of the bioreactor. Biofilm carriers are placed in the middle section of the bioreactor. The dual aeration system is mounted at the bottom section of the bioreactor. The membrane backwash system and the influent and effluent control devices are exterior to the bioreactor tank and can be arranged in multiple ways to best fit the allowable space.

The moving bed membrane bioreactor may comprise hollow fibre membrane modules. The modules may be in any suitable configuration such as, for example, linear loop pattern, circular loop pattern, twist pattern, or a combination thereof.

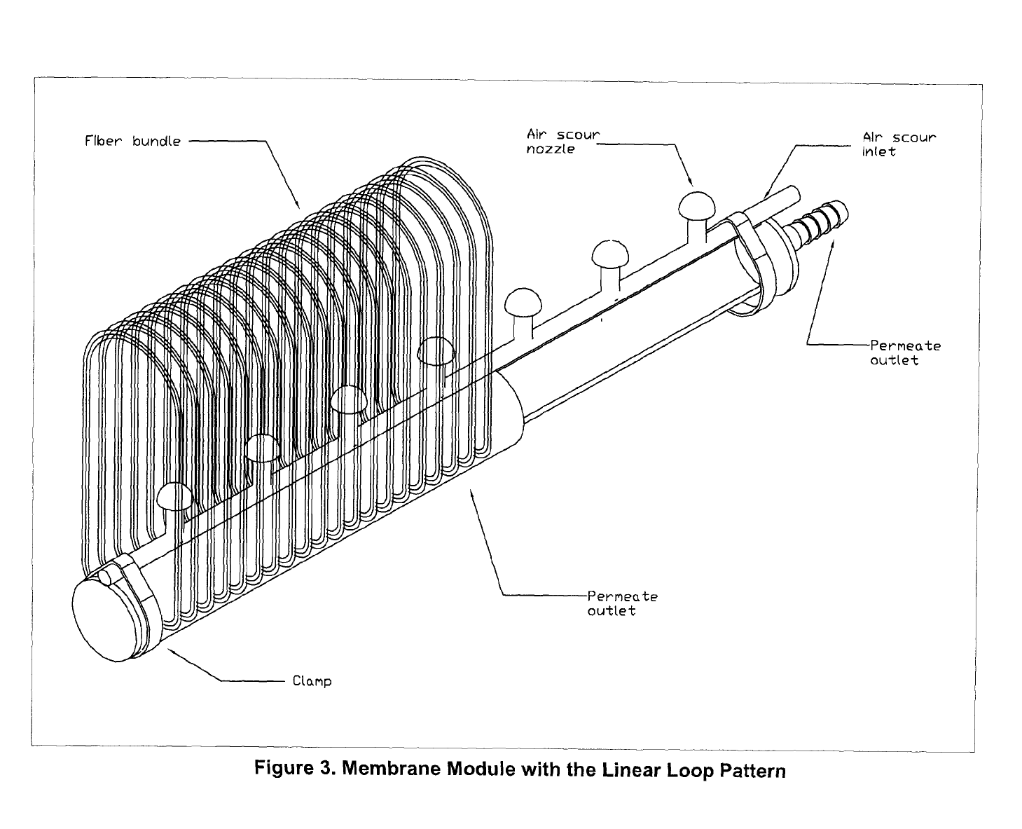

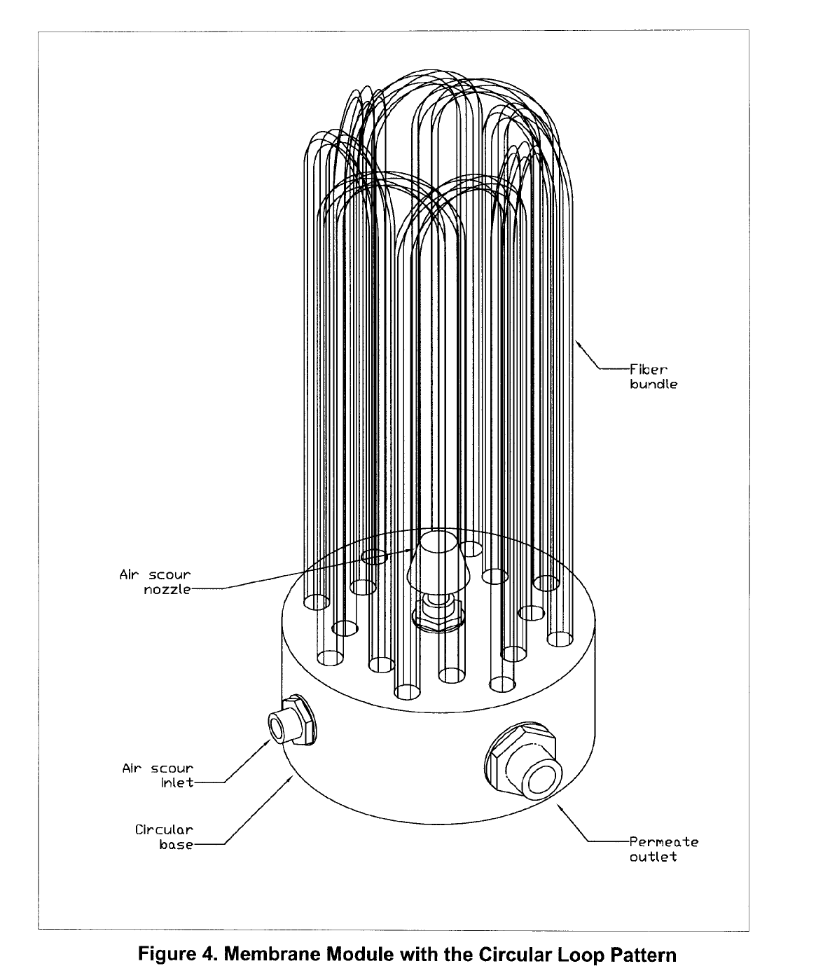

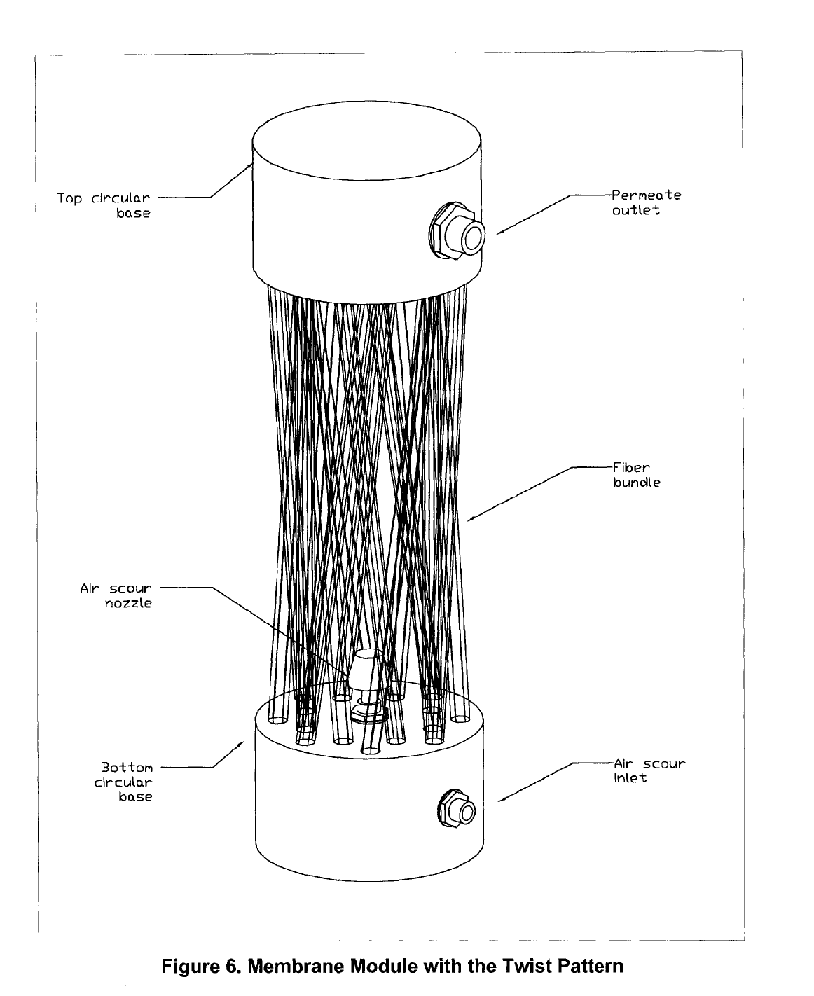

In the linear loop pattern as shown in FIG. 3, both ends of hollow fibre bundles may be potted into a single tube, which is connected to the permeate manifold. In the circular loop pattern as shown in FIG. 4, both ends of hollow fibre bundles may be potted into a single circular base, which is connected to the permeate manifold and air scour system. In the twist pattern as shown in FIG. 6, both ends of hollow fibre bundles may be potted into two circular bases. The top circular base may be connected to the permeate manifold and bottom base may be connected to the air scour system.

For the purpose of promoting and understanding of the principles of this invention, reference will now be made to the embodiments illustrated in the drawings, and specific language will be used to describe the same. It will be nevertheless understood that no limitations of the scope is thereby intended, such as alteration and further modifications in the illustrated device, and such further application of the principles of the invention as illustrated therein being contemplated as would normally occur to one skill in the art to which the invention relates.

FIG. 1 shows a schematic of a package plant according to the present disclosure. The pre-treatment system may comprise coarse and fine screens followed by an equalization tank with a recirculation system. Screening may be used to reduce membrane fouling. A 6-mm coarse screen removes debris, fibres and large solids, whereas a 3-mm fine screen removes smaller items such as hair or rags from the incoming wastewater before being discharged into an equalization tank. The equalization tank provides storage, and equalizes the flow to the bioreactor. The equalization tank may be equipped with a recirculation system to maintain solids in suspension, and to control odour and microbial re-growth. The recirculation system may comprise a recirculation pump and a UV radiation reactor, ozone contactor, or hydrogen peroxide contactor.

Wastewater from the equalization tank is conveyed to the bottom of the bioreactor by a feeding pump, which may be controlled by the water level in the bioreactor and the permeate pump flow. In the bioreactor, wastewater flows upwards through three defined zones: aerobic suspended growth zone, attached growth zone and membrane filtration zone.

In the aerobic suspended growth zone, organic matter is biodegraded by the suspended biomass into carbon dioxide, water and more biomass under continuous or intermittent injection of compressed air. The compressed air is conveyed to the bioreactor by a blower, air piping system and diffusers. The diffusers may be evenly distributed over the bottom of the bioreactor tank.

In the attached growth zone, the biomass attached to the biofilm carriers and converts ammonia to nitrite/nitrate in the aerobic condition, and then nitrite/nitrate to nitrogen gas in the anoxic condition. This may be achieved by careful control of the dissolved oxygen concentration in the tank such as, for example, by automatically turning on and off the aeration system every 20 minutes.

In the present disclosure, a portion of the waste sludge may be automatically withdrawn from both top and bottom of the bioreactor interchangeably to maintain a healthy population of microorganisms, a proper balance between active biomass and inert substances, and the designed solids retention time. To control the formation of foam and growth of filamentous bacteria, sludge may be withdrawn from the top of the bioreactor. To remove inert substances that have settled to the bottom, sludge may be removed from the bottom of the bioreactor.

In the membrane filtration zone, clean water is separated from the mixed liquor in the bioreactor and conveyed to the permeate tank by a permeate pump. Biomass and solids are retained on the outer surface of the membrane. The majority of them may be removed by the air scouring and membrane backwashing. The air scouring is applied continuously. The air bubbles are created by an air scour diffuser located at the center of the membrane module. The upward movement of the air bubbles dislodges the deposits on the membrane surface. Backwashing is carried out by periodically reversing the direction of the flow through the membrane, in conjunction with a short period of membrane relaxation. Further explanation of the backwash procedure is given below. The dislodged solids are returned by gravity back into the mixed liquor in the bioreactor. Chemical cleaning of the membrane may be carried out once per month, which is a routine maintenance.

In the present disclosure, the moving bed membrane bioreactor may contain a much higher biomass concentration than that of conventional MBRs. The high biomass concentration may be attributed to the use of membrane filtration and biofilm carriers. Membrane filtration retains the activated sludge in the bioreactor. Biofilm carriers may provide a large surface area for microorganisms to attach and form biofilm. The total biomass concentration in the bioreactor can reach as high as 9 g/m² of the attached biomass and 9,500 mg MLSS/L suspended biomass, which is equivalent to about 15,000 mg MLSS/L suspended biomass. High biomass concentrations in the bioreactor may provide a variety of advantages such as, for example, small reactor volume making the system compact; high contaminant removal efficiency; and/or high operational stability demonstrated as tolerance to toxic shocks and high fluctuations of wastewater flow-rate and organic load.

The present moving bed membrane bioreactor can provide for enhanced nitrogen removal in a single bioreactor tank, and results in a low residual nitrogen concentration in the reclaimed water. The high nitrogen removal efficiency may be attributed to the bioreactor configuration, which promotes the relative predominance of nitrifying bacteria over heterotrophic bacteria, and the advance aeration control system. Specifically, the aeration system may be turned on and off every 20 minutes, to create aerobic/anoxic environments needed for nitrification and de-nitrification, alternately. The above process design significantly reduces the number and volume of the bioreactors required.

The post treatment system is designed to disinfect permeate either before it is discharged to a storage tank or as it flows to its point of reuse. A UV radiation reactor may be used to disinfect the permeate. Ozonation and/or chlorination using sodium hypochlorite may also be option depending on the wastewater flow-rate and reuse applications. A small amount of chlorine amine may also be added in the treated water as a secondary disinfectant to prevent from the re-growth of microorganisms in the distribution pipeline when it is reused.

Bioreactor Tank

FIG. 2 shows one embodiment of the present bioreactor. The profile of the bioreactor is a cylinder placed vertically with a preferable height to diameter ratio of 3 to 5. This provides a compact structure with optimum hydrodynamic conditions, maximum oxygen transfer, and appropriate ratio of the amount of biomass and biofilm carriers in suspension. The bioreactor tank has a relatively small footprint which enables it to fit in a wide variety of situations.

The bioreactor tank can be opened from the top, as shown in FIG. 2. This allows access to various components inside of the bioreactor such as membrane modules, biofilm carriers, diffusers, etc. This facilitates installation and maintenance of the bioreactor. The bioreactor may be maintained closed by a removable cover and locked by several latches most of the time. This helps to avoid offensive odour being released from the bioreactor and to avoid accidental overflow of mixed liquor in the bioreactor. The off-gas outlet is installed on the top of the lid, and connected to an extraction fan to convey the off-gas outside of the building. The bioreactor is fitted with two adjustable retention sieves to maintain biofilm carriers in the middle section of the bioreactor. This protects the integrity of the diffusers and membrane modules. Adjustable retention sieves make it possible to expand or contract the height of biofilm carrier zone, depending on the nitrogen removal target. To adjust the position of the retention sieves four or more perforated channel strips may be mounted along the side of the bioreactor tank. The channel strips may have a series of perforation spaced, for example, every 25 mm. The position of the retention sieves may be thus adjustable using locking pins inserted in the perforation channel strips.

The bioreactor tank may be fitted with several ports such as, for example, an influent port, an effluent port, sampling ports, and/or instrumentation ports. The location of the ports is determined by the layout of the plant and site constraints. In one embodiment of the bioreactor, following ports are located at the top of the bioreactor tank: permeate outlet, waste sludge outlet, off gas outlet, sampling ports, and instrumentation ports. The following ports are located in the middle section of the bioreactor tank: air scour inlet, sampling ports and instrumentation ports. The following ports are located at the bottom section of the bioreactor tank: wastewater inlet, process air inlet, waste sludge outlet, drainage outlet, sampling ports, and instrumentation ports.

The present moving bed membrane bioreactor thus has a very flexible design that can be operated at different modes, such as conventional activated sludge biological treatment process, membrane bioreactor (MBR) process, moving bed biofilm reactor (MBBR) process or integrated some or all above processes. Moreover, the present moving bed membrane bioreactor can be used for either greywater or wastewater reclamation, to achieve the reclaimed water of the quality that can be reused.

Membrane Module

Existing MBR modules have several different configurations, such as hollow fibres, flat sheet, spiral wound, etc. For small scale package plants, hollow fibre membrane module can provide high packing density and large surface area in a small footprint. The hollow fibre membrane module is more compact than that of flat sheet modules, and less expensive. It can provide more flexibility for construction of the modules. However, commercially available hollow fibre membrane modules for a MBR are of the curtain type which occupies a large space. The existing modules are not always suitable for wastewater treatment because the membrane module may encounter high filtration resistance, insufficient aeration, and frequent membrane fouling.

Commercially available hollow fibre membranes are typically made of hydrophobic materials such as polyvinyldilene difluoride (PVDF) or polyethylsulphone (PES). They are susceptible to membrane fouling attributed to hydrophobic contaminants in wastewater.

The present hollow fibre membranes preferably have a hydrophilic surface. For example, the membrane modules may be made from surface modified hydrophilic PVDF fibres with a hydrophilic coating. This type of hollow fibre membrane may allow for large water flux (50 L/m²-hr) attributed to its asymmetric porous structure, high separation efficiency due to their narrow distribution of pore sizes (e.g. around 0.1 μm), and excellent anti-fouling characteristics.

The present hollow fibre membrane modules may be in different patterns such as linear loop pattern, circular loop pattern, and twist pattern. These patterns can significantly reduce membrane fouling; meanwhile, the membrane modules can be installed and operated in a vertical position.

In one embodiment the membrane module comprises hollow fibres arranged in a linear loop pattern as shown in FIG. 3. In this embodiment, both ends of fibre bundles are potted into a single permeate manifold. The bundles may be spaced equally. Each bundle may contain about 30 or more fibres. The length of each loop of the fibre may range from about 50 cm to about 120 cm. The total number of modules and/or bundles potted along the permeate manifold depends on the total surface area required for wastewater treatment, and determined by the wastewater flow-rate. The hollow fibre membrane used in the embodiment can, for example, provide a water flux rate of 20 L/m²-hr to 50 L/m²-hr. The calculation of the required membrane surface area is conservative. It was based on the assumption that water flux rate is equal to 20 L/m²-hr, despite that it can provide a water flux rate up to 50 L/m²-hr.

A membrane module with the linear loop pattern may be installed inside the bioreactor tank with the fibre bundles oriented parallel to the upwards flow. To reduce the range of fibre movement at the bottom of the bundles, a skirt may be fitted around the module. The linear loop pattern ensures the membrane bundles move freely in the mixed liquor of the bioreactor. The vibration of the membrane helps to reduce fouling. In the bioreactor, the permeate manifold is connected to the permeate header. The air scour manifold is bolted to the permeate manifold, so that the diffuser can be positioned inside fibre loop, which allows ascending bubbles to scour the membrane surface effectively. The present module may have several advantages such as, for example, the natural vibration of the bundles minimizing sludge build-up on the surface of the fibres; avoiding abrasion of the top of the bundle; differential water flux along the fibres is minimal due to the short length of the fibre loop and the short distance for the air scour to travel; the regular spacing between bundles ensures better solids removal from the bundle by the air scour; low incidence of membrane fouling, low requirement for cleaning, and expanded life-span of the membrane; its configuration is able to fit circular bioreactors; compact and robust; less cost of fibre material; and/or high membrane filtration efficiency.

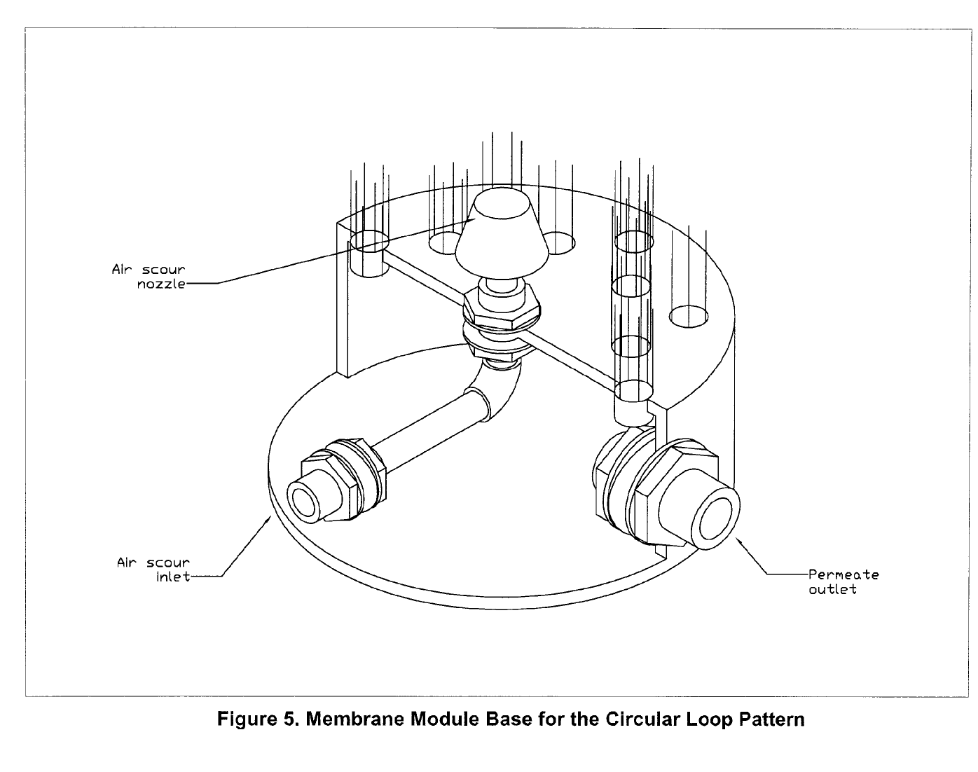

In an embodiment the membrane module comprises hollow fibres arranged in a circular loop pattern as shown in FIG. 4. In this embodiment, both sides of the fibre bundles are potted into a circular base. The circular base is then connected to the permeate manifold. The air scouring diffuser is positioned at the centre of the circular module base, as shown in FIG. 5. Each bundle may contain about 30 or more fibres. The fibre length of each loop may range from about 50 cm to about 120 cm. The total number of modules and/or bundles potted along the permeate manifold depends on the total surface area required for wastewater treatment, and determined by the wastewater flow-rate. The hollow fibre membrane used in the embodiment can, for example, provide a water flux rate of 20 L/m²-hr to 50 L/m²-hr. The calculation of the required membrane surface area is conservative. It was based on the assumption that water flux rate is equal to 20 L/m²-hr.

The membrane module with circular loop pattern may be installed inside the bioreactor tank with the fibre bundles oriented parallel to the upwards flow. An air scour nozzle at the center of the module base may inject air between the fibre bundles allowing the ascending bubbles to scour the fibres. The circular loop pattern helps ensure the membrane bundles move freely in the mixed liquor of the bioreactor. To reduce the range of the bottom fibre movement, a skirt may be fitted around the module. In the bioreactor, the permeate manifold is connected to the permeate header. The air scour manifold may be bolted to the permeate manifold, so that the diffuser can be positioned inside fibre loop, which allows ascending bubbles to scour the membrane surface. The present module may have several advantages such as, for example: solids, such as hair and cellulose fibres, can escape without build-up at the top of the fibre loop, differential water flux along the fibres is minimal due to the short length of the fibre loop and the short distance for the air scour to travel, the spacing between bundles aids solid removal from the bundle by the air scour, the natural vibration of the bundles helps minimize sludge build-up on the surface of the fibres, low incidence of membrane fouling, low requirement for cleaning, and expanded life-span of the membrane, configuration fits circular bioreactors, compact and robust, less cost of fibre material, and/or high membrane filtration efficiency.

In an embodiment of the membrane module the hollow fibres are arranged in a twist pattern, as shown in FIG. 6. The alignment of the twist membrane bundles is at certain angle while keeping the module installed and operated in vertical position. Aeration may be supplied at the bottom such that the membrane surface areas exposed to the rising air bubbles is increased, which has a consequent increase in air scouring effect and thus reduces membrane fouling. In this embodiment, membrane bundles are supported by both top and bottom circular holding bases. Both sides of the fibre bundles are potted into two circular bases. Membrane bundles potted at the inner layer are twisted clockwise while membrane bundles at the outer layer are twisted counter clockwise to provide coupling effect on the top and at the bottom holding bases. In other words, the internal bundles are inclined in opposite direction to the outside bundles. The top base is connected to the permeate manifold; whereas the bottom base is connected to the air scour manifold. Each bundle may contain about 30 or more fibres. The fibre length of each bundle may range from about 30 cm to about 60 cm. The total number of the bundles potted into the bases depends on the total surface area required for the wastewater treatment, which is calculated under the assumption of a conservative water flux rate of 20 L/m²-hr. The twist pattern membrane module is installed inside the bioreactor tank vertically with the module axes oriented parallel to the upward flow. The permeate manifold connects permeate headers. An air scour diffuser at the center of the module bottom base injects air between the fibre loops to allow the ascending bubbles to scour the fibres.

The present module may have several advantages such as, for example, differential water flux along the fibres is minimal due to the short length of the fibre loop and the short distance for the air scour to travel; the regular spacing between bundles helps ensure better solid removal from the bundle by the air scour; the natural vibration of the twist bundles helps reduce sludge build-up on the surface of the fibres; low incidence of membrane fouling, low requirement for cleaning, and expanded life-span of the membrane; configuration fits circular bioreactors; compact and robust; less cost of fibre material; and/or high membrane filtration efficiency.

Biofilm Carrier

The present bioreactors may comprise biofilm carriers to provide self controlling biomass, so that there is less need for monitoring and controlling biomass inventory in the bioreactor. The biofilm carriers also can offer the advantages in terms of increasing biomass concentration including, for example, nitrifying bacteria, and thus allowing for nitrification and denitrification to occur in a single bioreactor. The biofilm carriers can further reduce recalcitrant carbon or nitrogen and provide stability to the process under high organic loads or toxic loads. In addition, the carrier can break down the air bubbles into smaller bubbles which increase the oxygen transfer rate from air to water.

Various types of biofilm carriers can be used in the presented invention, including cylindrical high density polyethylene ring shape carrier, spherical polyvinyl alcohol (PVA) gel base carrier, and foam polymeric pieces. The densities of all these carriers are close to water density, so that they are easy to maintain in suspension in the bioreactor, which provides a larger surface area for microorganism to attach. However, some carriers can be clogged by the growing biomass, which can drastically reduce water or air flow through the carrier. Thus, appropriate selection of the biofilm carrier, in terms of size, surface area, density, and open structure, is important for the effective operation of the bioreactor as described here.

In this embodiment, a cylindrical high density polyethylene ring shape carrier was selected. The length to diameter ratio of the carrier ranges from 1.2 to 2. The carrier overall specific density with attached biofilm ranges from 1,200 to 1,300 kg/m³. The carriers may fill up to 67% of the tank volume. The specific surface area of the carriers ranges from 250 to 500 m²/m³.

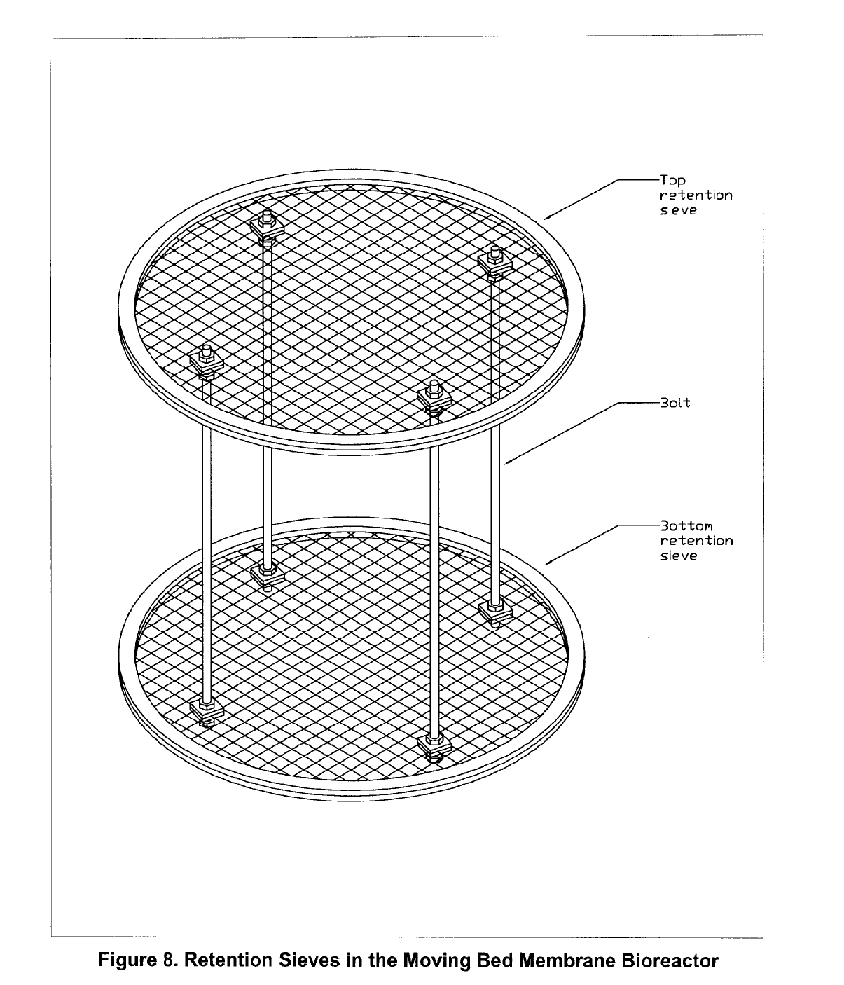

In this embodiment, the attached growth zone in the bioreactor is filled with biofilm carriers. The structure of carrier is similar to a turbine wheel. It contains four or more equally distributed internal walls, which extend in radial pattern from the center to the outside wall. The carrier may fill 20 to 67% of the tank volume, depending on carbon and nitrogen removal targets. The carriers are retained between two retention sieves as shown in FIG. 8, where their position can be adjusted vertically as described previously. The top retention sieve is located at about two third of the bioreactor height from the bottom, so that water and air are forced to pass through the inner passages of the carriers. In addition, the top retention sieve protects the membrane fibres against wear due to collision with the carriers. The bottom sieve protects the diffusers from the dead load of the carriers when the tank is emptied.

Aeration System

The present bioreactors may include a modified aeration systems for biodegradation of organic contaminants, mixing the mixed liquor in the bioreactor, and providing the vibration of membrane bundles to minimize sludge deposit onto the membrane surface and therefore minimize membrane fouling.

In one embodiment, the bioreactor is equipped with the modified aeration system, which may comprise an air blower, air piping and fittings, and coarse bubble diffusers. Sizing of the aeration system depends on the carbon and nitrogen removal targets. Consequently, sizing of the equipment varies from one application to another. Two or more blowers may be provided (one in use while the other is on stand by). The blower is typically located near to the bioreactor. A suitable air blower type for a small package plant is a regenerative or a positive displacement blower. The discharge of the blower may be fitted with a check valve to ensure that no water reach the blower motor. The air blower may be connected to a coarse bubble diffuser by an air header pipe and air manifold. The air header pipe may be equipped with two flow control valves to control the air flow rate of the coarse bubbles as well as to the air scour system. The coarse bubble diffusers may be located at about 3 inches from the bottom of the bioreactor.

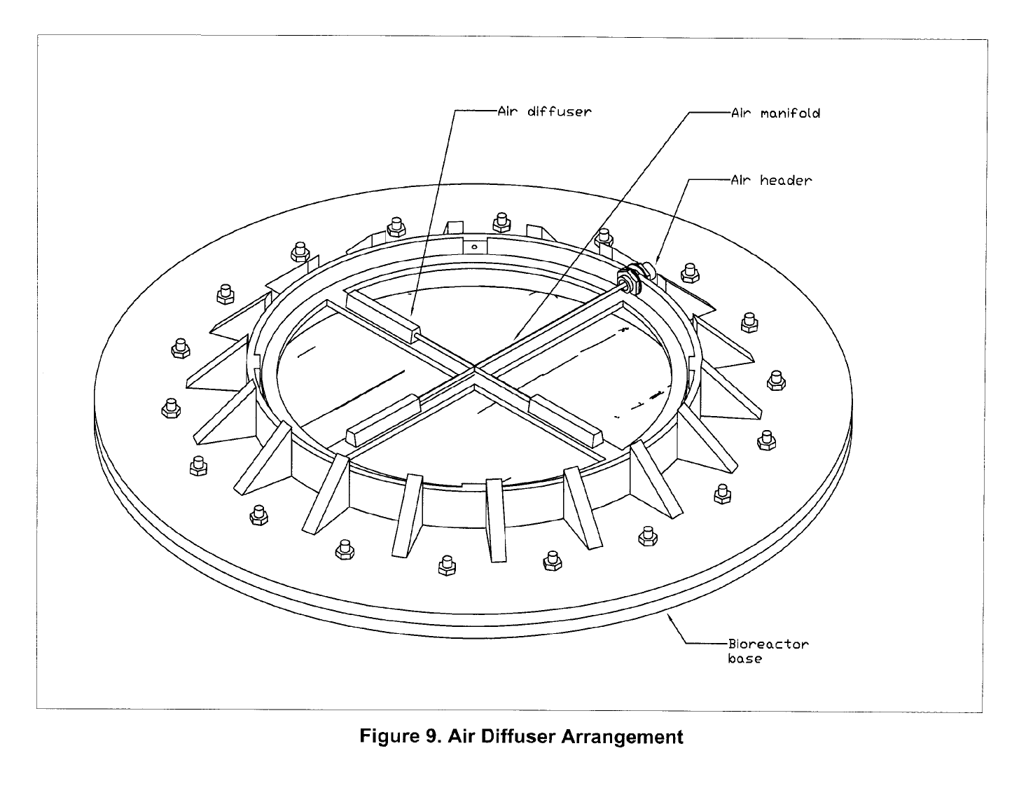

In one embodiment, the coarse bubble diffusers are arranged in a radial pattern, as shown in FIG. 9. The number of diffusers varies from 2 to 23 depending on the diameter of the bioreactor tank. The diffusers are connected to the air manifold, which in turn is connected to the main air header with a quick connector fitting for easy removal. Air flow rate to the coarse bubble diffusers may be controlled by the dissolved oxygen level in the bioreactor and a flow control valve located in the main air header line. Dissolved oxygen may be measured by a probe located above the attached grow zone. The preferable dissolved oxygen concentration ranges from 1 to 2 mg/L.

In an embodiment, a dual aeration system comprises coarse bubble diffusers (stone diffusers) for oxygen transfer and a perforated pipe air diffuser for mixing. The oxygen transfer diffusers ranged from 1 to 23 are arranged in a radial pattern as described above. The perforated pipe air diffuser may be arranged in a circular pattern mounted at the bottom of the bioreactor between the oxygen transfer diffusers and the wall of the bioreactor. The number and diameter of the perforation are designed to ensure equal distribution of air through each perforation. The perforated pipe air diffuser are connected to an air manifold, which in turn is connected to the main air header with a quick connector fitting for easy removal. Air flow rate to the oxygen transfer diffusers can be turned on and off every 20 minutes to promote nitrogen removal while the mixing diffusers maintain the bioreactor contents in suspension.

Air Scour System

The present bioreactor may be equipped with an air scour system to supply air for dislodging of solids accumulated on the membrane surface. The air scour system may comprise an air blower, air piping and fittings, and air scour diffusers. Sizing of the air scour system can be based on a conservative ratio, which ranges from 0.3 to 0.6 Nm³/h of air per square meter of membrane surface area. The air scour diffuser of each membrane module is connected to an air manifold, which in turn is connected to the main air header. Air scour flow rate may be controlled by a flow meter and a flow control valve located in the air manifold from the main air header to the air scour diffusers. The air scour can be operated continuously to prevent from membrane fouling.

Permeate—Backwash System

The present bioreactor may be equipped with a permeate-backwash system. It is used to convey permeate from the membrane modules to the permeate tank, and to periodically backwash the membrane surface by pumping disinfected permeate in reverse direction through the membrane fibres. This can effectively remove solids accumulated on the membrane surface, improve the permeability of the membrane, and ultimately reduce the pressure drop across the membrane. Over time chemical cleaning may be required to remove the irreversible fouling materials that cannot be removed by backwashing.

The filtration and backwash cycles may be continuously adjusted by an automated system, as described below.

Automation of the Filtration and Backwash Control Systems

The automatic filtration and backwash control system may be used to control the cycle of filtration production and backwash, and the rate of filtration. It can also be used to maintain a relatively constant water level within the bioreactor, continuously feed raw wastewater into the bioreactor, and stop the permeate pump when there is power outrage, so that the membrane modules are not exposed to the air due to the low level of mixed liquor in the bioreactor.

The duration of the filtration cycle may be controlled to avoid irreversible damage of the membrane material.

In an embodiment of the present system, the duration of the filtration and backwash cycles may be controlled based on the following parameters: 1) a pre-determined maximum allowable differential pressures for filtration, dP_{f,max}, and for backwash, dP_{b,max}; and 2) pre-determined maximum allowable duration for filtration, t_{fmax}, and backwash t_{b,max}. A controller regularly (e.g. continuously) monitors the differential pressure between a pressure sensor, P, located in the permeate/backwash line, and the initial pressure at the beginning of the cycle, Pₒ. The filtration or backwash cycle can be stopped when the differential pressure reaches a predetermined maximum allowable differential pressure or the maximum allowable time, whichever comes first. The controller may also stops the filtration cycle if the pressure reaches the maximum allowable vacuum pressure for the membrane module and, for example, may trigger the chemical in place surface washing process where the membranes are cleaned using a chemical solution.

The rate of filtration may be continuously adjusted to 1) avoid extended periods of microorganism starvation during periods of low influent flow to the equalization tank, and/or 2) maintain the water level in the bioreactor within a reasonable range. Water level in the bioreactor is preferably maintained above the top of the membrane modules to prevent air entrainment into the permeate line.

The rate of filtration can be continuously adjusted based on the water levels in the equalization tank and bioreactor. Specifically, the speed of the feed and permeate pumps are controlled based on the water level set points (target values) for both tanks. Thus, an increase of water level in the equalization tank will cause an increase in the feed pump speed, which will eventually lead to an increase in the bioreactor water level and an increase in the permeate pump speed.

Automation of the Plant Operation

In the present disclosure, an Expert System (ES) may be used to monitor and control the entire package plant automatically, especially filtration and backwash control systems. An ES is a computer system that performs difficult and specialized tasks at the level of a human expert. The automated on-line monitor and control system were developed to monitor process operations and treatment performance, and to control the operations automatically.

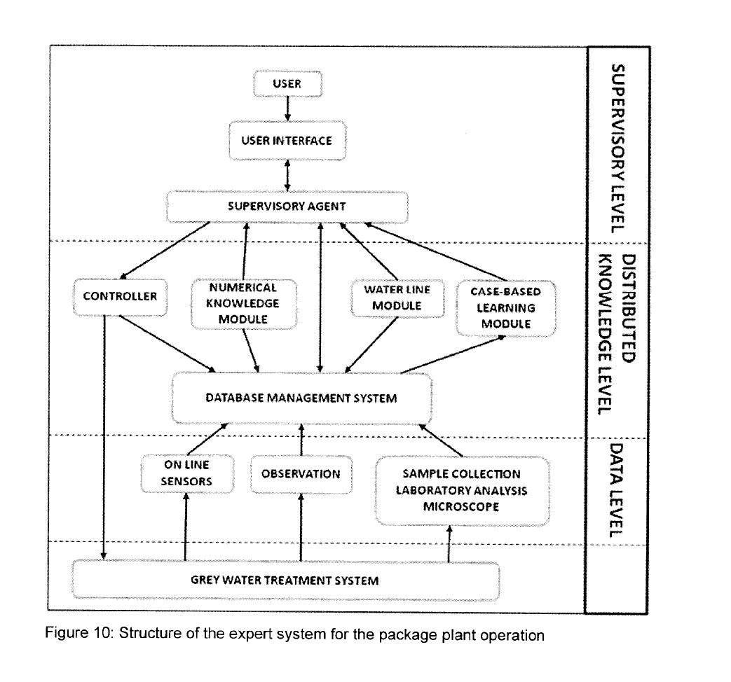

The integrated and distributed ES can supervise the control system of the whole treatment plant. The system has the capability to learn from the correct or wrong solutions given to previous cases. The structure of the suggested ES is analyzed and the supervision of the local controllers is described. In this way, the main problems of conventional control strategies and individual knowledge based intelligent systems are overcome. The structure of the expert system for the control of the package plant is shown in FIG. 10.

The ES may comprise several interacting subsystems (modules) that can be executed in parallel processing. The modules belong to three levels: data level, distributed knowledge level, and supervisory level. The general knowledge is obtained from interviews with experienced process engineers and operators. Data level (DL) receives all the information from various units of the package plant, and the influent and effluent. The following three categories of information are received and stored to the Data Base Management System (DBMS): 1) from a multiple on-line sensor to obtain pH, turbidity, dissolved oxygen, temperature, nitrate and ammonia, 2) from off-line laboratory analyses to obtain chemical oxygen demand (COD) and biochemical oxygen demand (BOD), and 3) from visual information describing the state of the plant such as water color, foaming in the bioreactor, species of the biomass in the mixed liquor, and odour. The last two categories of information are entered off-line and stored to the DBMS by the operators. The DBMS keeps records of all the monitored variables and sends the values to the higher levels, distributed knowledge and supervisory. The transmitting frequency of the various parameter values depends on the category that each parameter belongs, and on the control needs.

The distributed knowledge level (DKL) shown in FIG. 10 comprises four subsystems (modules): 1) Numerical knowledge module (NKM), 2) Water line module, 3) Case Based Learning Module (CBLM), and 4) controller.

The NKM, through a software program, can detect “outliers” or false measurements. Most often they are due to the problems caused during instrument calibrations, due to a random sensor malfunction, or due to a drift of a sensor. Sometimes they are due to human error. The NKM is capable of recognizing erroneous sensor readings, to compute a more likely value for these cases and to handle periodically missing data as well.

Water line module contains the modules with the KBSs of the various local units of the water line.

The CBLM supervises the operation of the Case Library. This is supplied by all the abnormal states of the plant. The solutions given to them are either correct or wrong. The Case Library is updated with the new information and learns from the past cases. In every abnormal state the ES compares the current situation with the recorded ones and according to the experience obtained, the operator makes his decision. In any case the ES is able to suggest a solution to the operator.

Controller is the module through which the final control of the plant is realized. Because of its many advantages a combination of feed forward and feedback control system is implemented for the activated sludge process using the data of the DBMS. The manipulated variables used are air flowrate for the control of dissolved oxygen concentrations, and amount of activated sludge wasted for the control of biomass concentration and sludge age.

The supervisory level (SL) shown in FIG. 10 is achieved by the supervisory module, which acts as the manager of the whole control system. It receives information from the distributed knowledge level and the DBMS, and then diagnoses the state of the package plant. This is normal if all the following conditions are true:

1. There are no divergences from the permitted limits of the effluent.

2. The measured and observed values of all the monitored parameters of the system are within the normal ranges.

3. There are no predictions for some abnormal input to the plant such as storm water or toxic substance loading.

If no operation problem is detected, the normal situation of the plant is actuated and the conventional automatic control system operates the whole plant.

If an abnormal situation is detected, then the supervisory agent infers the current state of the plant, which is compared with the most similar previous case. The experience already obtained, in combination with the rules of various knowledge bases, is used to give the same solution or a different one. The supervisory module or the operator either modifies the set points of the control system, or deactivates the control system and gives the proper orders to the on-line actuators. Sometimes manual operation may be required for some actions. The result of the given solution is a new experience, which is added to the old one.

The user interface module shown in FIG. 10 is used for the communication between the user and the supervisory module. In any case the supervisory module reaches to its own conclusion about the action to be taken but the user may decide and act differently. If additional information is required the ES requests it from the operator. Also if an impending upset is identified, the ES may provide an alert to personnel if necessary.

All citations are herein incorporated by reference, as if each individual publication was specifically and individually indicated to be incorporated by reference herein and as though it were fully set forth herein. Citation of references herein is not to be construed nor considered as an admission that such references are prior art to the present invention.

The invention includes all embodiments, modifications and variations substantially as hereinbefore described and with reference to the examples and figures. It will be apparent to persons skilled in the art that a number of variations and modifications can be made without departing from the scope of the invention as defined in the claims. Examples of such modifications include the substitution of known equivalents for any aspect of the invention in order to achieve the same result in substantially the same way. Unless otherwise indicated, reference to individual embodiments herein is not intended to be exclusionary and such embodiments may be combined with one another.

1. A moving bed membrane bioreactor package plant for greywater reclamation or wastewater treatment and reuse, comprising;
a. Pre-treatment system,
b. Moving bed membrane bioreactor, and
c. Post-treatment system.

2. The moving bed membrane bioreactor package plant of claim 1, wherein the pre-treatment system comprises:
a. A 6 mm coarse screen and a 3 mm fine screen for conducting primary filtration of wastewater;
b. An equalization tank for storage and equalization of wastewater flows and loads; and
c. A recirculation system to maintain solids in suspension, control offensive odour and microbial growth

3. The moving bed membrane bioreactor of claim 1, wherein the bioreactor comprises of a bioreactor tank, membrane modules, biofilm coolers, dual aeration system, air scour system, permeate and backwash system, and filtration and backwash control system.

4. (canceled)

5. The moving bed membrane bioreactor of claim 1, wherein the bioreactor comprises a bioreactor tank, the tank comprising a removal lid, perforated channel strips mounted along the internal wall of the tank, an inlet feed nozzled located at the bottom and a permeate outlet nozzled located at the top.

6. (canceled)

7. The moving bed membrane bioreactor of claim 1, wherein the bioreactor comprises a bioreactor tank in the form of a vertical circular column with the height to diameter ratio of about 3 to about 5.

8. The moving bed membrane bioreactor of claim 1, wherein the bioreactor comprises membrane modules, the modules being submerged into the liquor in the bioreactor at the top section of the bioreactor.

9. (canceled)

10. The moving bed membrane bioreactor of claim 1, wherein the bioreactor comprises membrane modules, the modules comprising fibres oriented parallel to the wastewater flow.

11. The moving bed membrane bioreactor of claim 1, wherein the bioreactor comprises biofilm carriers which are retained in the middle section of the bioreactor.

12. The moving bed membrane bioreactor of claim 1, wherein the bioreactor comprises a dual aeration system, the system comprising a circular perforated pipe diffuser and stone diffusers.

13.-16. (canceled)

17. The moving bed membrane bioreactor of claim 1, wherein the bioreactor comprises a permeated and backwash system comprising of a reversible pump and permeate tank to convey permeate from the inside of the membrane fibres to the permeate tank or to convey disinfected permeate from the permeate tank back to the bioreactor through the membrane.

18. The moving bed membrane bioreactor of claim 1, wherein the bioreactor comprises an automated filtration and backwash control system that regularly monitors the differential pressure between a pressure sensor, P, located in the permeate/backwash line and the initial pressure at the beginning of the filtration cycle, P₀.

19. (canceled)

20. The moving bed membrane bioreactor of claim 1, wherein the bioreactor comprises a membrane module comprising hollow fibres having a hydrophilic surface.

21. The moving bed membrane bioreactor of claim 1, wherein the bioreactor comprises a hollow fibre membrane module, the fibres having a linear loop pattern.

22. The circular loop moving bed membrane bioreactor of claim 1, wherein the bioreactor comprises a hollow fibre membrane module, the fibres having a circular loop pattern.

23. The moving bed membrane bioreactor of claim 1, wherein the bioreactor comprises a hollow fibre membrane module, the fibres having a twist pattern.

24. (canceled)

25. The moving bed membrane bioreactor of claim 1, wherein 25 and 67% of the bioreactor volume comprises biofilm carriers.

26. The moving bed membrane bioreactor of claim 1, wherein the bioreactor comprises biofilm carriers which are maintained in suspension by the continuous upward movement of the wastewater and air bubbles.

27. The moving bed membrane bioreactor of claim 1, wherein the bioreactor comprises the biofilm carriers having an effective surface area of 250 to 500 m²/m³ and overall specific density with attached biofilm of 1,200 to 1,300 kg/m³.

28. (canceled)

29. A process from treating wastewater or greywater in a moving bed membrane bioreactor comprising the steps of:
a. Feeding wastewater to the bottom of a bioreactor tank where biological processes reduce wastewater contaminants to such a low levels that permit effluent reuse;
b. Integrating suspended growth and attached growth activated sludge process in conjunction with membrane filtration process to provide an equivalent mixed liquor suspended solids of 15,000 mg, MLSS/L;
c. Providing nitrogen removal in a single bioreactor tank;
d. Providing upwards wastewater flow through the bioreactor;
e. Providing one or more membrane modules submerged into the mixed liquor so that the hollow fibre membranes can separate the permeate from the sludge under negative pressure provided by a pump;
f. Proving air scour bubbles to dislodge sludge accumulated on the surface of the membrane fibres;
g. Providing continuous circulation of oxygen enriched sludge from the surface of the membrane to the bottom of bioreactor;
h. Providing a perforated pipe for mixing and aeration, and
i. Providing automated control of membrane filtration and backwash units.

30. The process of claim 29, wherein air flow is cycled for 10 to 20 minutes of airflow OFF followed by 10 to 20 minutes of airflow ON and where the airflow rate is regulated automatically to maintain a dissolved oxygen concentration of 2 mg/L during the aerobic cycle and less than 1 mg/L during the pump off period.

31.-34. (canceled)
